(19) United States
(12) Patent Application Publication
(10) Pub. No.: US 2009/0281368 A1
(43) Pub. Date: Nov. 12, 2009

(54) Hearing aid system including implantable housing and exchangeable transducer

(76) Inventors: David A. Krubsack, Saugus, CA (US); Paul Kaluznick, St. Paul, MN (US)

Correspondence Address: Freilich Hornbaker & Rosen, 20555 Devonshire St #372, Chatsworh, CA, 91311, US

(21) Appl. No.: 12/310,513

(22) PCT Filed: Aug. 29, 2007
(86) PCT No.: PCT/US2007/018971

§ 371 Date: Feb. 25, 2009

Related U.S. Application Data
(60) Provisional application No. 60/845,858, filed on Sep. 20, 2006.

(51) Int. Cl. H04R 25/00

(52) U.S. Cl. 600/25

(57) ABSTRACT

A hearing aid system comprised of a housing configured for subcutaneous implantation having a portion configured to extend percutaneously into a patient's outer ear canal. The percutaneous portion is configured to functionally mate with a transducer capable of being readily exchanged via said outer ear canal.

### FIELD OF THE INVENTION

This invention relates generally to hearing aid systems and more particularly to a system including an implantable housing configured to accommodate a transducer in a manner enabling the transducer to be readily exchanged, or replaced, via a patient's outer ear canal.

### BACKGROUND OF THE INVENTION

U.S. patent application Ser. No. 10/702,565 filed on Nov. 5, 2003, which is incorporated herein by reference, describes a hearing aid system including an implant configured for subcutaneous placement in a recess formed between a patient's retro-auricular space and outer ear canal. The implant is described as comprising a case containing an antenna, electronic circuitry, and a transducer. The transducer functions to convert electrical signals supplied from the implant electronic circuitry into sound energy for projection into the patient's ear canal.

U.S. patent application Ser. No. 10/821,383 filed on Apr. 9, 2004, which is incorporated herein by reference, describes an implantable percutaneous device, and method of implantation, especially configured to promote soft tissue ingrowth for creating an infection resistant barrier and for anchoring the implanted device in place.

PCT application PCT/US2004/041596, filed on 10 Dec. 2004, which is incorporated herein by reference, describes a surgical instrument set and procedure for implanting a hearing aid housing so as to locate a transducer proximate to a patient's outer ear canal. In a preferred embodiment, the transducer is mounted in a housing stud which projects through a percutaneous hole opening into said outer ear canal.

### SUMMARY OF THE INVENTION

The present invention is directed to a hearing aid system comprised of a housing configured for subcutaneous implantation and having a portion configured to extend percutaneously into a patient's outer ear canal. The percutaneous portion is configured to functionally mate with a transducer module capable of being readily exchanged via said outer ear canal.

In one preferred embodiment of the invention, the housing defines a cavity opening into the patient's outer ear canal configured to accommodate a transducer module adapted to be inserted into and withdrawn from the cavity.

In one preferred embodiment, the transducer module carries one or more terminals configured to electrically contact mating terminals on the housing when the transducer is properly seated in the cavity. In an alternative embodiment, the transducer module carries an electric coil configured to inductively couple to an electric coil in the housing when the transducer module is properly seated in the cavity.

An exchangeable transducer module in accordance with the invention is comprised of at least one electrically driven speaker for directing sound energy into said outer ear canal and/or at least one microphone responsive to acoustic energy in the outer ear canal for generating an electric signal to drive another device, e.g., a cochlear implant.

### BRIEF DESCRIPTION OF THE FIGURES

FIG. 1 is a side view schematically showing a subcutaneously implanted housing having a portion, or stud, extending percutaneously into a patient's outer ear canal;

FIG. 2 is an enlarged cross sectional view taken through the housing of FIG. 1 showing a cavity in the housing stud and a transducer module configured for insertion into and removal from the cavity;

FIG. 3 is a representative isometric view showing electric terminals on the transducer module configured to contact mating terminals on the housing when the transducer module is seated in the cavity;

FIG. 4 is a sectional view similar to FIG. 2 but showing the transducer module partially inserted into the housing cavity with the assistance of a tool having a pair of tines;

FIG. 5 is a sectional view taken substantially along the plane 5-5 of FIG. 4;

FIG. 6 is a sectional view taken substantially along the plane 6-6 of FIG. 5; and

FIG. 7 is a sectional view of an alternative embodiment in which the housing and exchangeable transducer module are inductively coupled.

### DETAILED DESCRIPTION

Attention is initially directed to FIG. 1 which illustrates a hearing aid system housing 10 implanted primarily in a patient's subcutaneous tissue 12. The housing comprises a body portion 13 and a stud 14 projecting from the body portion percutaneously through skin tissue 16 into the patient's outer ear canal 18. A housing similar to that depicted in FIG. 1 is described in aforementioned patent application Ser. No. 10/821,383. The housing 10 includes a longitudinally extending body portion surface 21, a laterally oriented shoulder surface 22, and a longitudinally extending stud surface 23. A layer of porous material 24 is preferably affixed to the longitudinal body portion surface 21, the longitudinal stud surface 23, and the lateral shoulder surface 22 for promoting healthy tissue ingrowth to form a bacteria resistant barrier. As described in said application Ser. No. 10/821,383, the porous layer 24 is preferably formed by a mesh of intersecting fibers of a suitable biocompatible material such as a metal, e.g., titanium, nitinol, silver, or stainless steel or a polymeric material, e.g., polyolefins, Teflon, nylon, Dacron, or silicone. The mesh is preferably formed by cross winding the fibers in multiple layers to define a porosity conducive to promoting tissue ingrowth, e.g., with pore sizes within a range of 50 to 200 microns and having a porosity of 60 to 95%. Also, it is generally desirable to apply a coating containing one or more antimicrobial and/or anti-inflammatory agents on the housing exterior surface and/or porous layer to promote tissue healing and/or resist infection and inflammation. Suitable agents are known in the literature and include, for example, antibiotics, silver compounds, and steroid based agents.

The aforementioned application PCT/US2004/041596 describes a preferred surgical instrument set and procedure for implanting the housing 10 with the stud 14 extending through a percutaneous hole 26 in tissue 16 into the outer ear canal 18. The preferred housing described in said PCT/US2004/041596 houses a power supply and electronic circuitry for driving an electroacoustic transducer mounted in the stud for projecting sound energy directly into the patient's outer ear canal.

The present invention is directed to an enhanced hearing aid system in which a percutaneously extending portion of an implanted housing, i.e., stud portion, is configured for detachably mounting a transducer module which can be readily exchanged via the patient's outer ear canal. The ability to exchange the transducer module via the outer ear canal without disturbing the implanted housing considerably enhances the reliability of the hearing aid system and permits system performance to be upgraded as improved transducers become available. The teachings of the present invention are applicable to systems in which the transducer module carries at least one electrically driven sound generator, e.g., speaker, for directing sound energy into the outer ear canal and/or at least one microphone, for responding to acoustic energy in the outer ear canal for generating a representative electric signal for driving another device, e.g., a speaker or cochlear implant.

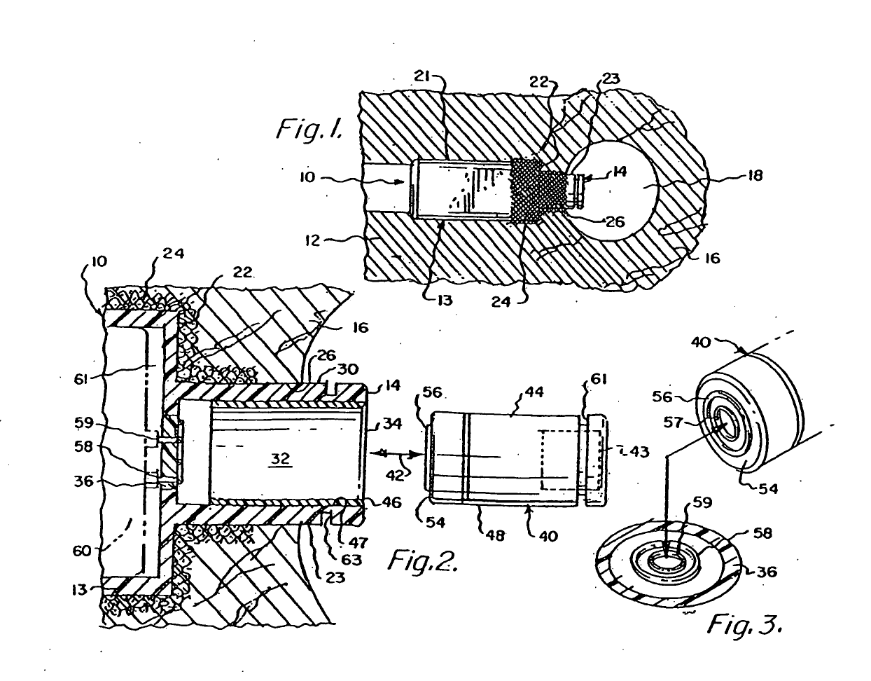

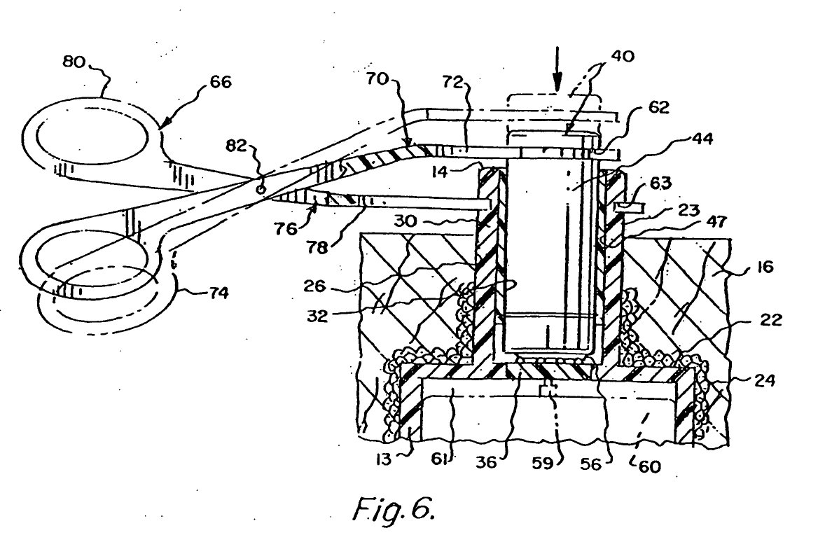

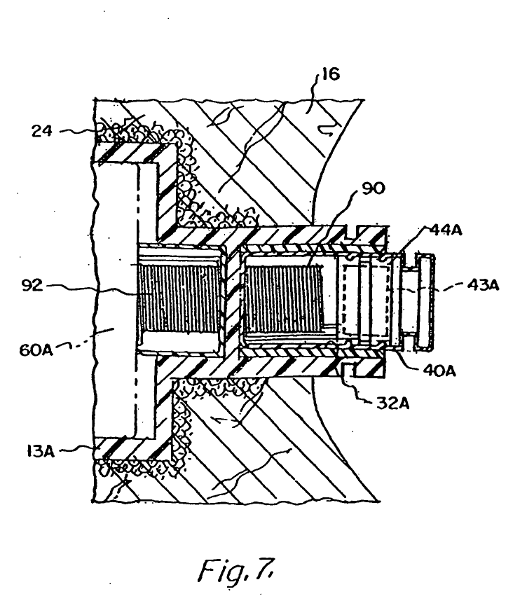

Attention is now directed to FIGS. 2-6 which illustrate a first preferred embodiment of the present invention. FIG. 2 is a partial cross section of the housing 10 showing the subcutaneously implanted body portion 13 and the percutaneously extending stud 14. Note that the stud 14 comprises a peripheral wall 30 which surrounds a cavity 32 bounded by an open cavity entrance 34 and a cavity floor 36. The periphery of cavity 32 can be shaped in a variety of manners, e.g., square, hexagonal, etc., but unless otherwise stated, it will be assumed hereinafter that the cavity is cylindrical. The cavity 32 is intended to accommodate a similarly shaped transducer module 40 which is configured for easy insertion into and withdrawal from the cavity, as represented by the two-headed arrow 42. The transducer module 40 is comprised of one or more transducer elements, e.g., one or more speakers and/or microphones, and electronic circuitry 43, mounted within a transducer module body 44. A compliant liner 46, e.g., silicone, is preferably mounted in the cavity 32 attached to the inner surface 47 of peripheral wall 30 to frictionally engage and closely seal against the outer surface 48 of the transducer module body 44.

The transducer module body 44 includes a bottom wall 54 carrying one or more externally accessible electric terminals 56, 57 which connect through the bottom wall to transducer circuitry (not shown) housed within the body 44. The transducer terminals 56, 57 are located so as electrically contact fixed terminals, e.g., 58, 59, mounted on the cavity floor 36. The terminals 58, 59 connect through the floor 36 to electronic circuitry 60 mounted within compartment 61 of housing body portion 13.

In the embodiment shown in FIGS. 2 and 3, the transducer body 44 is configured to slide into cavity 32 to seat transducer terminals 56, 57 against fixed terminals 58, 59. It is recognized that in alternative configurations, not shown, the transducer module body 44 and cavity 32 can be differently configured, e.g., with mating threads, to allow the body 44 to be rotated into the cavity 32 to seat transducer terminals 56, 57 against fixed terminals 58, 59.

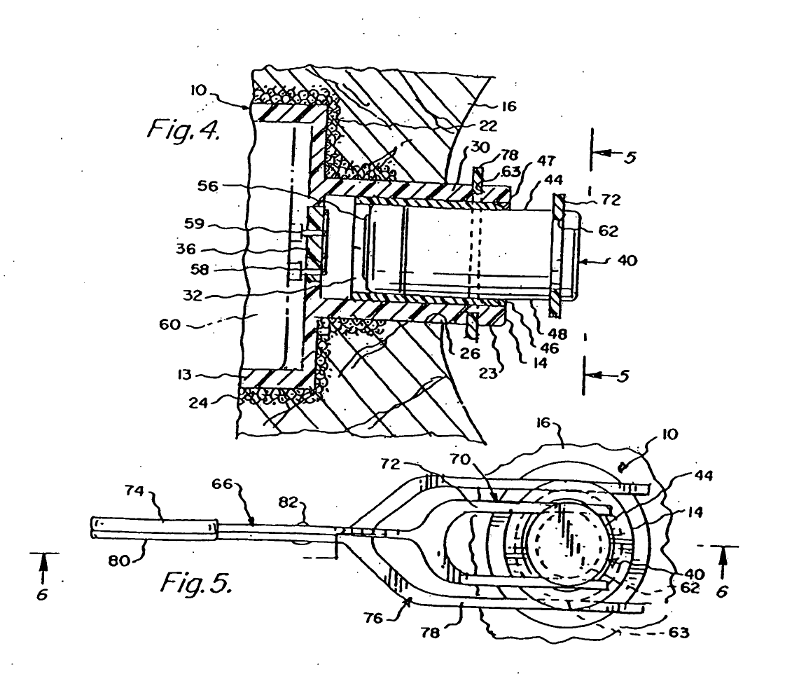

In order to facilitate the insertion and withdrawal of the transducer body 44 relative to the cavity 32, it is preferable to provide an annular slot 62 in the outer surface 48 of body 44 and an annular slot 63 in the outer surface 23 of stud wall 30. These annular slots can be used in conjunction with a preferred dual tine tool 66 (FIGS. 4-6) configured to be inserted by a technician into the patient's outer ear canal for inserting the transducer body 44 into the cavity 32 or extracting the body from the cavity.

More particularly, the tool 66 (FIGS. 4-6) is comprised of a first, or outer, member 70 having a U-shaped tine 72 on one end and a handle 74 on the other end and a second, or inner, member 76 having a U-shaped tine 78 and a handle 80 on opposite ends. The first and second members are hinged around pivot point 82 so that when handles 74 and 80 are squeezed by the technician, tines 72 and 78 move toward one another. Conversely, when handles 74 and 80 are moved apart, tines 72 and 78 move apart.

In use, a technician will, via the patient's outer ear canal, engage outer tine 72 in slot 62 and inner tine 78 in slot 63. Then by separating handles 74 and 80, the transducer module body 44 will move relative to stud wall 30 to extract the body from the cavity 32. The technician can then replace the extracted body 44 by placing a new transducer module at the cavity entrance 34 and engaging tines 72 and 78 with slots 62 and 63, respectively. By then squeezing the handles 74, 80, the new transducer module can be forced into the cavity 32 to cause transducer terminals 56, 57 to electrically contact fixed housing terminals 58, 59.

Attention is now directed to FIG. 7 which shows an alternative to the embodiment illustrated in FIGS. 2-6. Whereas the embodiment of FIGS. 2-6 electrically couples transducer 40 to electronic circuitry 60 via contacting terminals 56, 57 and 58, 59, the embodiment of FIG. 7 instead relies on inductive coupling. More particularly, the transducer module 40A in FIG. 7 includes at least one electric coil 90 mounted in transducer module body 44A. Body 44A is configured for insertion into, and extraction from, cavity 32A in the same manner as has been previously discussed relative to FIGS. 2-6.

The housing body portion 13A in FIG. 7 houses at least one coil 92 preferably mounted in close proximity to the cavity 32A to inductively couple coils 90 and 92 when the transducer body 44A is seated in cavity 32A. The coil 92 is electrically connected to electronic circuitry 60A in the housing body portion 13A. The coil 90 is electrically connected to a transducer element, e.g., speaker or microphone, and electronic circuitry 43A in the transducer module body 44A. Thus, the inductively coupled coils 90, 92 are able to transfer electric signals representative of sound energy between the electronic circuitry 60A and the transducer element and circuitry 43A.

From the foregoing, it should now be understood that the present invention is directed to a system in which an implanted hearing aid is configured to allow the easy replacement of a transducer module via the patient's outer ear canal. Although only a limited number of embodiments have been described herein, it is recognized that additional variations and modifications may occur to those skilled in the art. For example, alternatives to frictional engagement of the transducer module and the housing could also include threaded attachment means or locking mechanisms, etc.; alternatives to electrical contacts could also include the use of pins, etc. Additionally, alternative geometries can be employed to optimize inductive coupling of the coils 90, 92. Yet additional variations and modifications which are consistent with the spirit and teachings of the invention and which are intended to fall within the scope of the appended claims are also likely to occur to those skilled in the art.

1. A hearing aid system including:
a housing configured for implantation proximate to a patient's outer ear canal, said housing including a mounting stud configured to percutaneously project into said outer ear canal;
electronic circuitry mounted in said housing;
a transducer module configured for detachable mounting to said stud via said outer ear canal; and
means coincident with mounting said transducer module to said stud for electrically coupling said transducer module to said electronic circuitry.

2. The system of claim 1 wherein said mounting stud includes a cavity opening into said outer ear canal; and wherein
said transducer module is configured for insertion into and withdrawal from said cavity.

3. The system of claim 1 wherein said means for electrically coupling includes at least one electric transducer terminal on said transducer module; and
at least one electric housing terminal on said mounting stud located for contact by said transducer terminal when said transducer module is mounted to said mounting stud.

4. The system of claim 1 wherein said means for electrically coupling includes at least one electric transducer coil carried by said transducer module; and
at least one electric housing coil carried by said housing located for inductive coupling to said transducer coil when said transducer module is mounted to said mounting stud.

5. The system of claim 1 wherein said transducer module includes a speaker for projecting acoustic energy into said patient's outer ear canal.

6. The system of claim 1 wherein said transducer module includes a microphone for responding to audible sound in said patient's outer ear canal.

7. The system of claim 1 further including a porous layer on the exterior of said housing for promoting tissue ingrowth.

8. The system of claim 1 wherein said transducer module comprises body containing a transducer element and electronic circuitry.

9. A hearing aid system including:
a housing configured for implantation proximate to a patient's outer ear canal, said housing including a mounting stud configured to percutaneously project into said outer ear canal;
electronic circuitry mounted in said housing;
a transducer module configured for detachable mounting to said stud via said outer ear canal;
at least one electric contact positioned on said housing; and
at least one electric contact positioned on said transducer module for electrically coupling said transducer module to said electronic circuitry coincident with mounting said transducer module to said stud.

10. The system of claim 9 wherein said mounting stud includes a cavity opening into said outer ear canal; and wherein
said transducer module is configured for insertion into and withdrawal from said cavity.

11. The system of claim 9 wherein said transducer module includes a speaker for projecting acoustic energy into said patient's outer ear canal.

12. The system of claim 9 wherein said transducer module includes a microphone for responding to audible sound in said patient's outer ear canal.

13. The system of claim 9 further including a porous layer on the exterior of said housing for promoting tissue ingrowth.

14. The system of claim 9 wherein said transducer module comprises a body containing a transducer element and electronic circuitry.

15. The system of claim 9 wherein said housing carries a coating including an anti-microbial and/or anti-inflammatory agent.

16. A hearing aid system including:
a housing configured for implantation proximate to a patient's outer ear canal, said housing including a mounting stud configured to percutaneously project into said outer ear canal;
electronic circuitry mounted in said housing;
a transducer module configured for detachable mounting to said stud via said outer ear canal;
at least one electric coil in said housing; and
at least one electric coil in said transducer module located for inductive coupling to said housing coil when said transducer module is mounted to said mounting stud.

17. The system of claim 16 wherein said mounting stud includes a cavity opening into said outer ear canal; and wherein
said transducer module is configured for insertion into and withdrawal from said cavity.

18. The system of claim 16 wherein said transducer module includes a speaker for projecting acoustic energy into said patient's outer ear canal.

19. The system of claim 16 wherein said transducer module includes a microphone for responding to audible sound in said patient's outer ear canal.

20. The system of claim 16 further including a porous layer on the exterior of said housing for promoting tissue ingrowth.

21. The system of claim 16 wherein said transducer module comprises a body containing a transducer element and electronic circuitry.

22. The system of claim 16 wherein said housing carries a coating including an anti-microbial and/or anti-inflammatory agent.

23. A method for configuring an implanted hearing aid, said method comprising:
providing a body having a stud portion projecting therefrom;
providing a transducer module configured to detachably mount to said stud portion;
surgically implanting said body subcutaneously in a recess formed between a patient's retroauricular space and outer ear canal such that said stud portion projects percutaneously into said outer ear canal; and
detachably mounting said transducer module to said stud portion through said patient's outer ear canal.

24. The method of claim 23 wherein said step of mounting said transducer module to said stud portion includes using a tool insertable through said outer ear canal for moving said transducer relative to said stud.

25. The method of claim 23 wherein said method further includes electrically coupling said transducer module to said body coincident with mounting said transducer to said stud portion.
